(19) United States
(12) Patent Application Publication
(10) Pub. No.: US 2014/0354086 A1
(43) Pub. Date: Dec. 4, 2014

(54) ELECTRICAL MACHINE WITH CONTACT CONNECTORS

(71) Applicants: COMPAGNIE GENERALE DES ETABLISSEMENTS MICHELIN, CLERMONT-FERRAND (FR); Michelin Recherche et Technique S.A., GRANGES-PACCOT (CH)

(72) Inventor: Bertrand Vedy, Clermont-Ferrand (FR)

(21) Appl. No.: 14/363,863

(22) PCT Filed: Dec. 6, 2012
(86) PCT No.: PCT/EP2012/074631

§ 371 Date: Jun. 9, 2014

(30) Foreign Application Priority Data
Dec. 9, 2011 (FR) 1161417

(51) Int. Cl. H02K 5/22; H02K 15/12; H02K 15/00; H02K 15/04; H01R 4/18; H02K 11/00

(52) U.S. Cl. CPC H02K 5/225; H01R 4/18; H02K 11/0094; H02K 15/0068; H02K 15/0435; H02K 15/12; H02K 2203/06
USPC 310/43; 310/71; 29/596

(57) ABSTRACT

An electrical machine includes permanent magnets, a housing, a stator winding contained in the housing, and a cover. The cover includes at least two contactors and is connected to an electrical harness. The stator winding has at least two phase outputs, with at least one electrical connector being fixed to each phase output of the stator winding. Each of the electrical connectors has a contact surface intended to cooperate with a contact element. When the cover is installed on the housing, each contactor of the cover is in contact with a contact surface of a corresponding electrical connector fixed to a phase output of the stator winding, such that the electrical machine is connected to the electrical harness.

### FIELD OF THE INVENTION

The present invention relates to electrical machines, in particular intended for installation in road vehicles.

The present invention in particular relates to electrical machines with a stator winding. This invention can be applied, for example, with permanent magnets in brushless electrical machines.

An electrical machine is a machine enabling the conversion between electrical energy and mechanical energy. This conversion can be implemented in both directions without the need for the machine to function as a generator or as a motor. There are different types of machines, that is to say D.C. machines or A.C. machines, which can be further sub-divided into synchronous or asynchronous machines. In order to perform this conversion, an electrical machine generally comprises a fixed part, referred to as a stator, and a rotatable part, referred to as a rotor.

The electrical machines can be installed in all sorts of systems, in particular in a road vehicle, and more specifically in a wheel of a road vehicle. In such a particular configuration, one of the challenges of installation of an electrical machine lies in the connection of the machine to the external connections, in the present case an electrical harness of the vehicle. In the case of a brushless machine with permanent magnets, the electrical machine is connected for its part at the stator.

The prior art discloses an electrical machine in which the electrical connection to the external elements is ensured by the crimping of winding conductors formed of flexible multi-strand wire connected to a pin of a three-pin connector, each pin corresponding to the three phases of the winding.

This crimping is encased in a coating resin as closely as possible to the cooled surfaces of the electrical machine in order to ensure good thermal behaviour of the assembly. At the other end of the flexible multi-strand wire, a second crimping should be produced in order to fix a contact of the connector.

It is thus acknowledged that the installation of an electrical machine connected in this way is relatively complex. In fact, it requires two crimping procedures, moreover for each of the three phases of the stator, which means that six crimping operations have to be performed.

In addition, such an installation may pose problems with regard to reliability in the event of subsequent disassembly of the machine. In fact, in the event of disassembly, it must be decided whether to leave the multi-strand wire in place, and in this case extreme care must be taken to avoid any damage, or whether to disconnect the multi-strand wire from the connector side, in which case a new crimping operation must be carried out subsequently during reassembly.

### BRIEF DESCRIPTION OF THE INVENTION

The object of the present invention is to propose an electrical machine that does not have these disadvantages.

More specifically, the object of the present invention is to propose an electrical machine such that the disassembly is relatively easy and such that said electrical machine can adapt to different applications without the need for specific adaptations.

The present invention thus relates to an electrical machine with permanent magnets comprising a housing containing a stator winding with at least two phase outputs, said electrical machine comprising

at least one electrical connector fixed to each phase output of the winding,

a cover comprising at least two contactors and connected to an electrical harness, each electrical connector having a contact surface intended to cooperate with a contact element,

the machine being such that, when the cover is installed on the housing, each contactor of the cover is in contact with a contact surface of an electrical connector and the electrical machine is connected to the electrical harness.

For the purpose of clarification, two different terms, contactor and connector, are used in the present description to denote elements that are separate elements, but are the same in essence, that is to say electrical contacts or contactors.

A machine according to the invention has the advantage of requiring a single step of fixation of electrical connectors to the phase outputs. In fact, the second step of crimping described in the prior art is no longer necessary since the electrical connection of the machine is implemented by a simple contacting of a contactor of the cover with a contact surface of an electrical connector installed on a phase output of the winding.

In addition, this connection provided by a simple contacting procedure enables an improved adaptability of the cover and of the electrical machine. It is thus possible to modify one of the elements without having to modify the other, since the geometry of the contact points remains the same. Such a solution thus makes it possible to save costs since there is no need to produce machines specifically for each application.

In addition, a machine according to the invention enables a disassembly and easy access to the different elements. Such a feature is particularly beneficial in the case in which an electrical machine is installed on a wheel, since the wheel arch is an area that is particularly difficult to access.

The fixing of the electrical connector to a phase output of the winding is selected from the group comprising: crimping, welding, clamping of the wires by a screw.

In a specific embodiment of the invention each electrical connector comprises:

a lower portion (which can be attached) bearing a fixing element for fixing to the winding, and

an upper portion bearing the contact surface,

the lower and upper portion forming an angle substantially equal to 90° and the lower portion, the upper portion, the fixing element and the contact surface forming a single mechanical part. The electrical connector is made of a conductive metal material, for example copper.

The machine preferably further comprises at least one insulating part cooperating with each electrical connector so as to prevent any contact between the upper portion of the electrical connector and the winding or the carcass of the machine. This part is made of injection-moulded plastic, for example.

The invention also relates to a method for producing an electrical machine, comprising the following steps:

an electrical connector is fixed to each phase output of a stator winding, said electrical connector comprising a planar portion extending in the axis of the electrical machine and bearing the fixing element for fixing to the winding,

the winding is installed in a sleeve and the coils are shaped,

the planar portion of the connector is then folded so as to form a lower portion of the connector bearing the fixing element, an upper portion of the connector having a contact surface.

The positioning of the electrical connector and the subsequent folding thereof mean that the shaping of the coils is not hindered, this shaping process being necessary within the scope of production of an electrical machine.

In a specific embodiment of the invention the lower portion and the upper potion of the connector form an angle substantially equal to 90° at the end of the folding step.

In addition, in a further embodiment of the invention the method comprises, before or after the folding of the connector, the step of coating the windings and the coils with an impregnating resin. In this case, the lower portion of the connector is also encased in a coating resin.

Furthermore, in a further embodiment of the invention, the method comprises the final step of installing a cover comprising three contact elements, each intended for contact respectively with each contact surface of an electrical connector. It is thus noted that the invention proposes a relatively simple production method, since the final connection of the electrical machine is implemented by a simple contacting of the cover with the elements installed beforehand.

In a specific example of the invention the step in which an electrical connector is fixed to a phase of the winding is selected from the group comprising: a crimping step, a welding step, a step of clamping the wires by a screw.

In a final further embodiment the method comprises, prior to the folding step, the step of placing a shaping part intended to insulate the upper portion of the connector from the winding and the carcass of the electrical machine.

### BRIEF DESCRIPTION OF THE DRAWINGS

Further objectives and advantages of the invention will become clear from the following description of a preferred, but non-limiting embodiment illustrated by the following figures, in which:

FIG. 1 shows a view of an electrical machine comprising three electrical connectors without the cover,

FIGS. 2a and 2b show two views of an electrical connector installed on a phase of a winding,

FIG. 3 shows an example of the cover,

FIG. 4 shows an outer view of an electrical machine comprising a cover shown transparently,

FIG. 5 shows a sectional view of an electrical machine and its cover, and

FIG. 6a shows an electrical connector before folding, and FIG. 6b shows a folding step.

### DESCRIPTION OF A PREFERRED EMBODIMENT OF THE INVENTION

In the description of the figures, like elements in the figures will be denoted by the same reference.

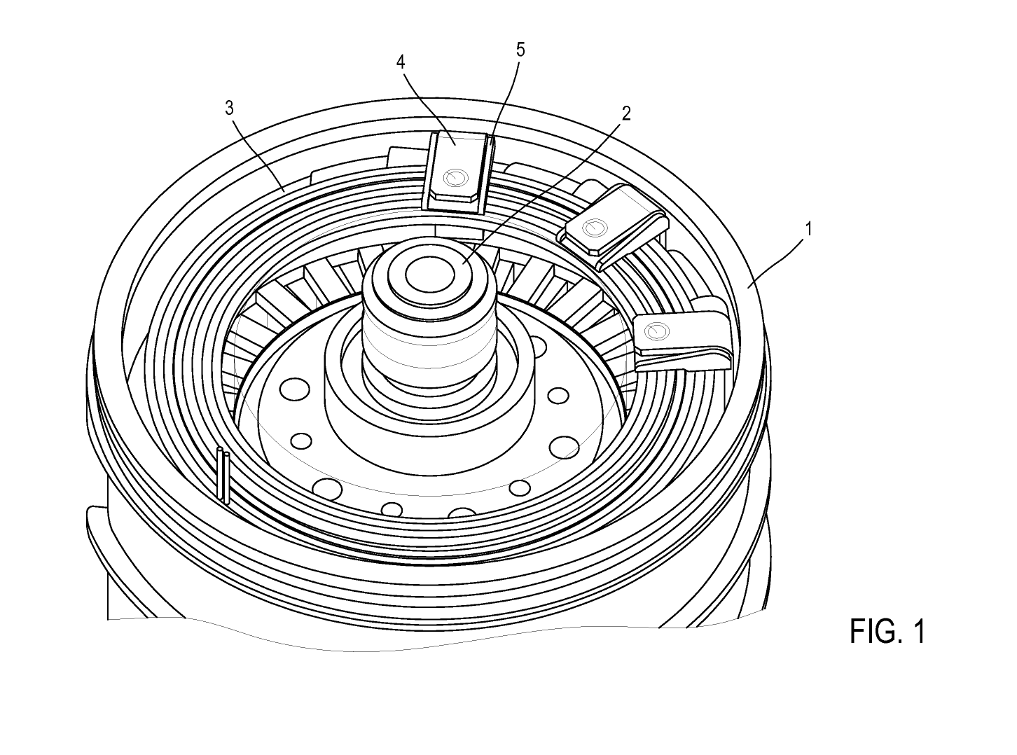

FIG. 1 shows a brushless electrical machine with permanent magnets. This machine is shown without its cover. The machine comprises a housing 1, in which a rotor 2 is installed in the axis of the housing, surrounded by a stator winding 3. This winding is three phase, that is to say the coils define three phases. In the example in FIG. 1, the machine comprises 3 identical connectors 4, each installed on an output of the winding. Furthermore, each connector is shaped around an insulating part 5.

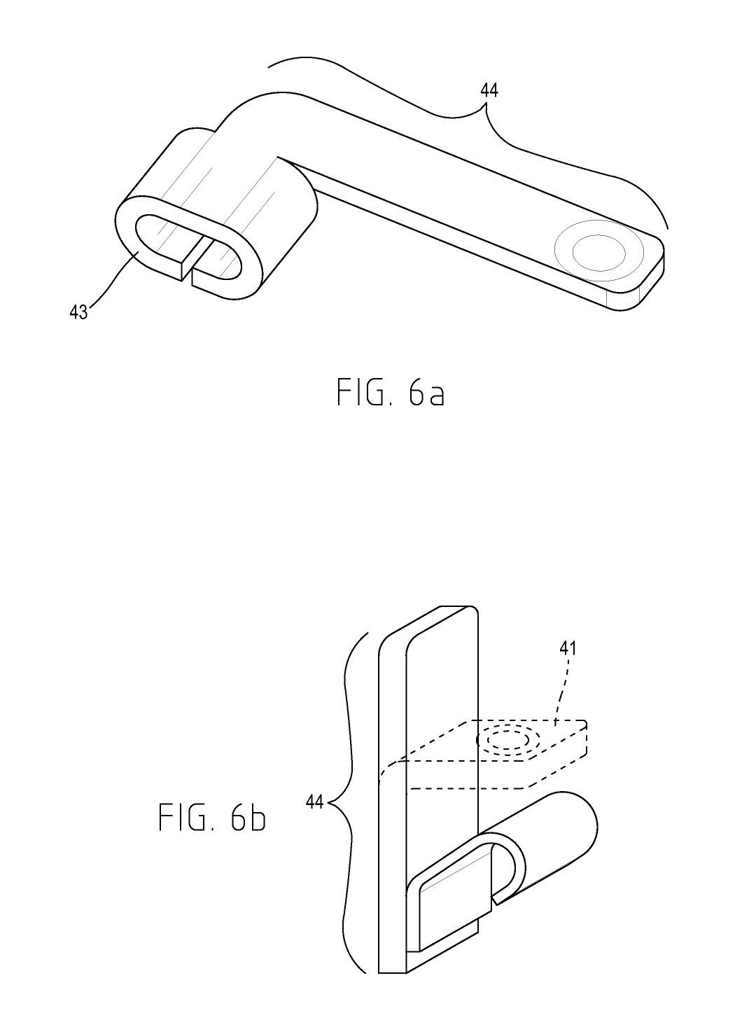

An electrical connector such as those shown in FIG. 1 is, initially, a non-folded conductive metal part, as shown in FIG. 6. During production of the electrical machine, a non-folded connector is fixed on a phase output of the stator winding. To this end, a fixing element 43 is crimped on a phase output, for example comprising three wires, so as to establish a connection.

This crimping procedure is performed once the stator windings have been wound. At this stage, the connector is still in an unfolded state, as shown in FIG. 6, and the planar portion 44 of the connector is arranged in the axis of the housing 1, which is shown in FIG. 1. This means that the following step is not hindered, said step consisting of shaping the coils. In accordance with the embodiments, it is also possible, at this stage of the production method, to coat the windings and the coils with an impregnating resin.

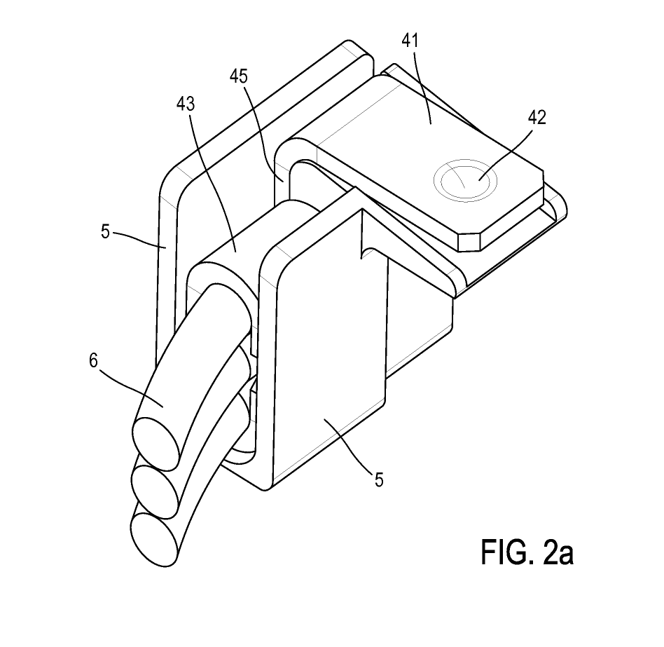

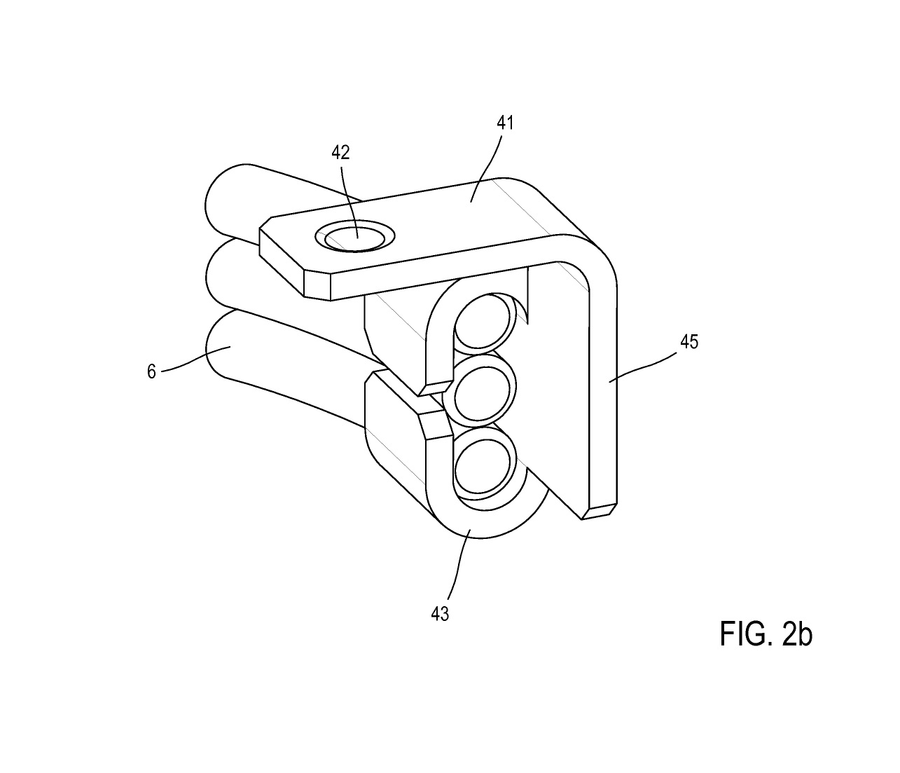

The planar portion 44 is then folded so as to form, as shown in FIGS. 2a and 2b, an upper portion 41 comprising a contact surface 42, and a lower portion 45, not visible in FIG. 2a, bearing the fixing element 43. This folding is preferably performed around an insulating part 5. This part, for example made of injection-moulded plastic, makes it possible to prevent the upper portion 41 from coming into contact with the windings during the folding of the connector and insulates contact with the housing.

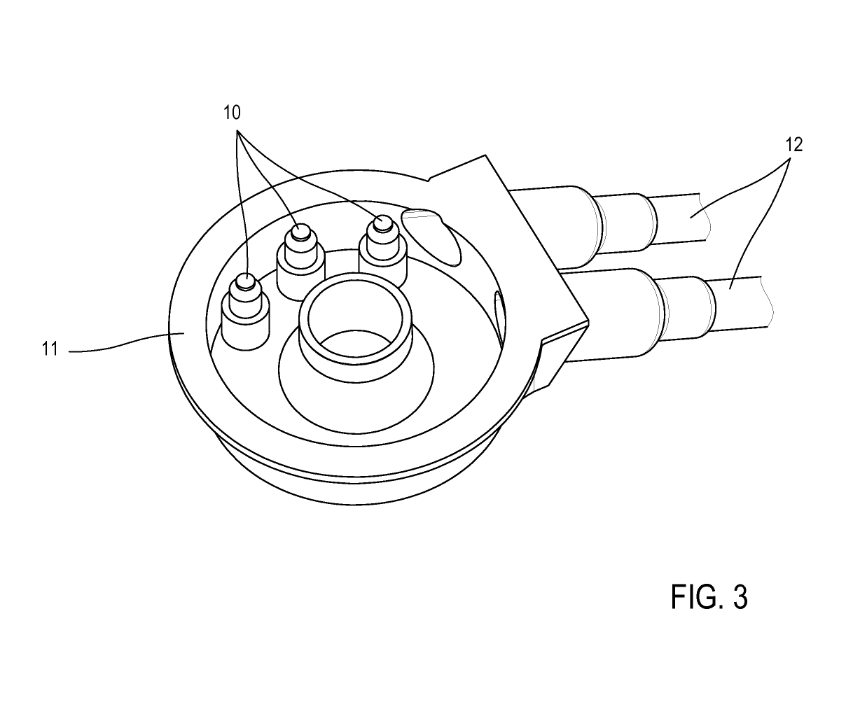

Once the three connectors have been installed and folded as described above, the electrical machine thus comprises three connectors providing three contact surfaces for contact with the surface of the stator winding. These three contact surfaces are arranged so as to be able to cooperate with three contactors 10 installed in a cover 11 as shown in FIG. 3.

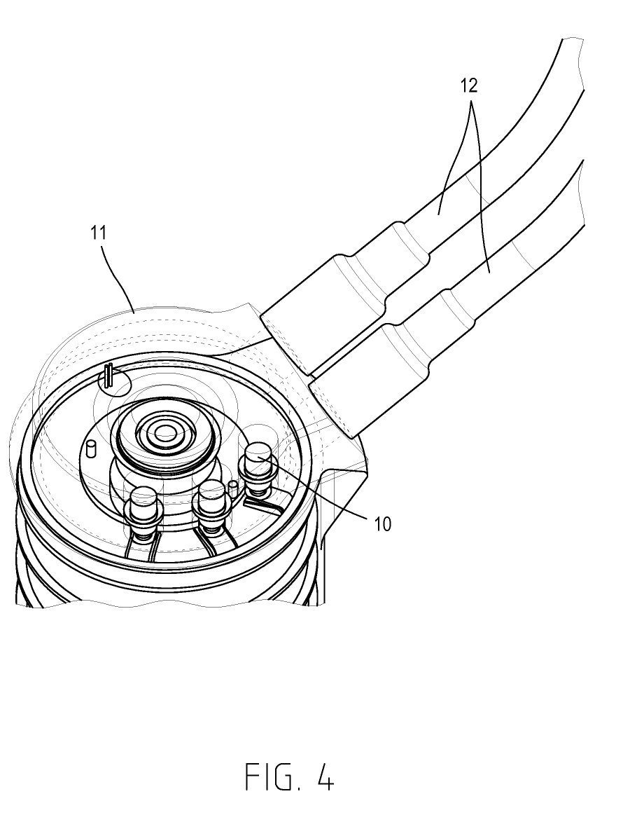

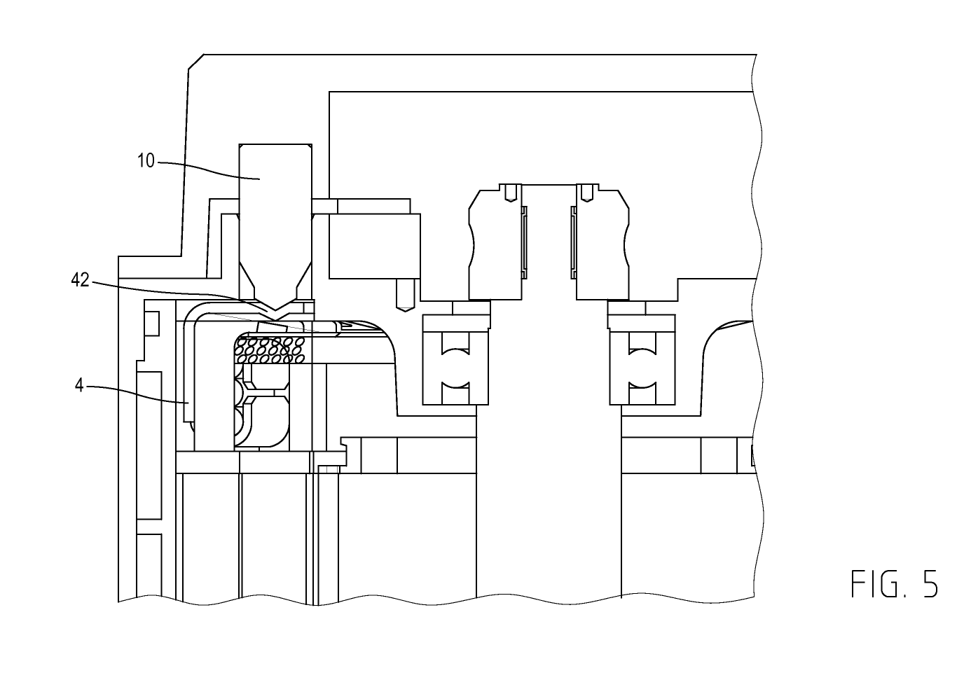

As the cover 11 is placed in position, the three contactors 10 come into contact with the contact surfaces 42. FIGS. 4 and 5 show this contact: in FIG. 4 the cover is transparent so as to make it possible to see the contactors 10 and the connectors 4.

The cover 11 comprises sheaths 12, making it possible to pass through the electrical connections which will be connected on one side to the contactors 10 and on the other side to the system in which the electrical machine is installed, for example a road vehicle. In an example, one of the sheaths is thus arranged so as to receive the three power wires connected to the three contactors, and the other sheath is arranged to receive the connections used to take measurements, in particular thermal measurements or resolver positioning measurements. It should be noted that, in FIG. 3, the power wires connecting the contactors 10 to the electrical harness are not shown.

A number of advantages of an electrical machine according to the invention are acknowledged here. In fact, such a machine firstly makes it possible to produce a single type of start, whatever the adopted choice of connection. Consequently, such a machine offers an economical solution compared with the existing solutions

In addition, the geometry of the electrical connectors makes it possible to integrate them within a limited volume, thus ensuring a good compactness of the assembly. In fact, the present invention makes it possible to omit a flexible multi-strand wire, thus reducing the volume required for the connection. In addition, only one crimping operation is necessary, which makes it possible to facilitate the connection and the disconnection of the electrical machine and thus to simplify the maintenance of the electrical machine.

1-12. (canceled)

13: An electrical machine that includes permanent magnets, the electrical machine comprising:
a housing;
a stator winding contained in the housing, the stator winding including at least two phase outputs;
at least one electrical connector fixed to each phase output of the stator winding; and
a cover that includes at least two contactors, the cover being connected to an electrical harness,
wherein each electrical connector has a contact surface arranged to cooperate with a corresponding contact element, and
wherein, when the cover is installed on the housing, each contactor of the cover is in contact with a contact surface of a corresponding electrical connector fixed to a phase output of the stator winding, such that the electrical machine is connected to the electrical harness.

14: The electrical machine according to claim 13,
wherein each electrical connector includes:
a lower portion bearing a fixing element for fixing to the stator winding, and
an upper portion bearing the contact surface,
wherein the lower portion and the upper portion form an angle substantially equal to 90°, and
wherein the lower portion, the upper portion, the fixing element, and the contact surface are formed of a single mechanical part.

15: The electrical machine according to claim 14, further comprising at least one insulating part cooperating with each electrical connector so as to prevent any contact between the upper portion of the electrical connector and the stator winding.

16: The electrical machine according to claim 15, wherein each insulating part is made of injection-moulded plastic.

17: The electrical machine according to claim 13, wherein each electrical connector is fixed to a corresponding phase output of the stator winding by crimping, or by welding, or by clamping of wires using a screw.

18: The electrical machine according to claim 13, wherein each electrical connector is made of copper.

19: A production method for producing an electrical machine, the method comprising steps of:
fixing an electrical connector to each phase output of a plurality of phase outputs of a stator winding of the electrical machine, each electrical connector including a planar portion extending along an axis of the electrical machine and bearing a fixing element that fixes to the stator winding;
shaping coils of the stator winding and installing the stator winding in a sleeve; and,
for each electrical connector, folding the planar portion of the electrical connector so as to form a lower portion and an upper portion, wherein the lower portion bears the fixing element, and wherein the upper portion has a contact surface.

20: The production method according to claim 19, wherein, at completion of the folding step, the lower portion and the upper portion of each electrical connector form an angle substantially equal to 90°.

21: The production method according to claim 19, further comprising a step of, before or after the folding step, coating the stator winding including the coils with an impregnating resin.

22: The production method according to claim 19, further comprising a step of, after the folding step, installing a cover that includes a plurality of contact elements, the contact elements structured to contact, respectively, the electrical connectors fixed to the phase outputs of the stator winding.

23: The production method according to claim 19, wherein the fixing step is selected from: a crimping step, a welding step, and a clamping step in which a screw is used to clamp wires.

24: The production method according to claim 19, further comprising a step of, for each electrical connector, prior to the folding step, arranging a shaping insulator part to insulate the upper portion of the electrical connector from the stator winding.
